(19) United States
(12) Patent Application Publication
(10) Pub. No.: US 2019/0210211 A1
(43) Pub. Date: Jul. 11, 2019

(54) Gripping Device

(71) Applicant: Lawrence Strathmore Reece, Hamilton (CA)

(72) Inventor: Lawrence Strathmore Reece, Hamilton (CA)

(21) Appl. No.: 16/226,807

(22) Filed: Dec. 20, 2018

Related U.S. Application Data
(63) Continuation of application No. 62/596,227, filed on Dec. 8, 2017.

(51) Int. Cl. B25G 1/10

(52) U.S. Cl. CPC B25G 1/102; B62J 99/00

(57) ABSTRACT

A gripping device for a tubular member, such as a bicycle seat tube, is provided. The gripping device comprises an elongated tubular body having an outer layer, inner layer and opposite open ends. The inner wall is capable of adhering to the body of the tubular member, such as the seat tube. When the gripping device is applied to a bicycle, for example, the gripping device disclosed herein allows for an improved grip of the bicycle and correspondingly a reduced strain on a user who wants to transport the bicycle.

### FIELD

The present disclosure relates to accessories for tubular devices. In particular, the present disclosure relates to gripping devices for tubular members, such as handle bars, and methods of using the same.

### BACKGROUND

Gripping devices are known.

For example, U.S. Pat. No. 5,023,128 discloses an impact absorbing pad which includes a plurality of parallel, elongated, and individually sealed hollow pneumatic tubes with coextensive webbing. Each tube includes opposing lengthwise interior ridges. Upon compression of a tube, the trapped air is compressed and the ridges contact each other, resisting compression and pressing outwardly to spread the force of impact.

U.S. Pat. No. 4,977,621 discloses a one-piece multi-purpose hand-cushioning device providing protection to the palm area of the hand from trauma associated with athletic and job-related activities. The device embodies a grip enhancement feature useful in many activities requiring prolonged use of the hands, such as driving, carpentry, etc., and may be used as a therapeutic aid for users with physical limitations due to crippling effects of arthritis, muscular dystrophy, and other diseases affecting the joints and muscles of the hands and fingers. The pad is manufactured from die cut neoprene with a bonded nylon backing, with or without an additional bonded raised cushion in the palm area. Four finger holes are provided thus eliminating the requirement for any type of fasteners. The object to be gripped is thus held between the fingers and the pad more securely and with less effort than with the hand alone. Because of its symmetrical design, the pad may be worn on either hand.

U.S. Pat. No. 4,893,369 discloses a utensil for floor cleaning and other surface treatment comprising a pad, for example, of sponge material, releasably attached by clips to the handles of a hinged holder. The handles form a grip for enabling the utensil to be held for use and also enable the hinged parts of the holder to be pressed together to squeeze the pad.

U.S. Pat. No. 4,754,858 discloses a cushioning pad for relieving the strain of carrying luggage. The pad is removable and attachable to a plurality of luggage pieces by means of a pair of stretchable elastic bands provided in the cushioning pad by through holes positioned at each end thereof. The cushioning pad can be used on handheld luggage as well as luggage using an over-the-shoulder strap. The stretchable elastic bands are used to not only secure the cushioning pad to the luggage handle or strap, but are also used to join a plurality of luggage pieces using the same cushioning pad. A plurality of hangers contained within one garment bag can also be joined together by one of the pair of elastic bands, with the other one of the pair of elastic bands used to secure the cushioning pad to the handle of the garment bag.

A need, therefore, exists for the development of a product and/or method that obviates or mitigates at least one of the disadvantages described above or that provides a useful alternative.

### SUMMARY

In an aspect there is provided a gripping device for attachment to a tubular member, the device comprising: an elongated tubular body comprising an outer layer, an inner layer and opposite open ends, wherein the inner layer has a first surface for connecting to the outer layer and a second surface for connecting to the tubular member and wherein the device is orientatable between an open configuration wherein a first edge and a second edge of the inner layer and/or the outer layer are drawn away from each other forming a longitudinal opening and a closed configuration wherein the first edge and the second edge of the inner and/or the outer layers are drawn together.

In aspects, the device described herein further comprises a seam member.

In aspects, the seam member comprises a planar body and a projecting member connected to, extending along, a length of the planar body.

In aspects, the seam member is insertable within the longitudinal opening and attachable to the first and second edges of the inner and/or outer layer of the body.

In aspects, the seam member spans a portion of the longitudinal opening or spans an entire length thereof.

In aspects, the seam member further comprises a backing member, wherein when the backing member is removed, the seam member can be attached to the first edge and second edge of the inner layer and/or outer layers.

In aspects, the device described herein further comprises at least one recess and at least one ridge formed in a surface of the gripping device.

In aspects, the surface is a surface of the outer layer and/or the inner layer of the gripping device.

In aspects, there is at least one recess and at least one ridge are positioned to conform to a placement of fingers of a hand.

In aspects, the device described herein further comprises fastening elements configured to secure the gripping device to the tubular member.

In aspects, the fastening elements are hook and loop fasteners.

In aspects, the tubular member is selected from the group consisting of a seat tube, a garden tool, a handle bar, a walking cane, and a ski pole.

In another aspect, there is provided a gripping device for attachment to a tubular member, the device comprising: an elongated tubular body comprising an outer layer, an inner layer and opposite open ends, wherein the inner layer has a first surface for connecting to the outer layer and a second surface for connecting to the tubular member and wherein the device is orientatable between an open configuration wherein a first edge and a second edge of inner and/or the outer layer are separated from each other to form a longitudinal opening and a closed configuration wherein the first edge and the second edge of the inner layer and/or the outer layer are connected through a seam member.

In aspects, the seam member comprises a planar body and a projecting member extending along a length of the planar body.

In aspects, the seam member further comprises a backing member, wherein when the backing member is removed, the seam member can be attached to the first and the second edge of the inner layer and/or outer layer.

In aspects, the device described herein further comprises at least one recess and at least one ridge formed in a surface of the gripping device.

In aspects, the surface is a surface of the outer layer and/or the inner layer of the gripping device.

In aspects, there is at least one recess and at least one ridge that are positioned to conform to a placement of fingers of a hand.

In aspects, the device described herein further comprises fastening elements configured to secure the gripping device to the tubular member.

In aspects, the tubular member is selected from the group consisting of a seat tube, a garden tool, a handle bar, a walking cane, and a ski pole.

In further aspects, there is provided a gripping device for a bicycle seat tube comprising: an elongated tubular body having an outer layer, inner layer and opposite open ends, the inner layer being capable of adhering the body to the seat tube.

In yet further aspects, there is provided a gripping device for a bicycle seat tube comprising: at least one sheet of material having an outer layer and an inner layer, wherein the inner layer is capable of adhering at least one sheet of material to the seat tube.

In aspects, the device described herein further comprises at least one recess and at least one ridge formed in a surface of the gripping device.

In aspects, the surface being referenced, is a surface of the outer layer of the gripping device.

In still further aspects, there is provided a gripping device for a bicycle seat tube comprising: an elongated tubular body having an outer layer, inner layer and opposite open ends, wherein the inner layer is capable of allowing the body to be adhered to the seat tube, and wherein the outer layer has at least one recess and at least one ridge formed in a surface thereof.

In aspects, the body further comprises a longitudinal opening having opposing edges.

In aspects, the inner layer adheres to a portion of the seat tube.

In aspects, the portion of the seat tube is a top tube.

In aspects, the portion of the seat tube is a down tube.

In aspects, the device described herein further comprises fastening elements configured to secure the gripping device to the seat tube.

In aspects, the fastening elements are hook and loop fasteners.

In aspects, the hook and loop fastener is Velcro.

In yet still further aspects, there is provided a gripping device for attachment to a tubular member, the device comprising: an elongated tubular body comprising an outer layer, an inner layer and opposite open ends, wherein the inner layer is capable of allowing the body to be adhered to the tubular member.

In aspects, the outer layer comprises a first edge and a second edge connectable to the first edge of the outer layer.

In aspects, the inner layer comprises a first edge and a second edge connectable to the first edge of the inner layer.

In aspects, the first edges of the inner and outer layer can be drawn away from the second edges of the inner and outer layers to form a longitudinal opening along a length of the body.

In aspects, the device described herein further comprises a seam member.

In aspects, the seam member comprises a planar body and a projecting member extending along a length of the planar body.

In aspects, the seam member is insertable within the longitudinal opening and attachable to the first and second edges of the inner and/or outer layer of the body.

In aspects, the seam member spans a portion of the longitudinal opening or spans an entire length thereof.

In aspects, the seam member further comprises a backing member, wherein when the backing member is removed, the seam member can be attached to the first and second edges of the inner layer and/or outer layer.

In yet still further aspects, there is provided a gripping device for attachment to a tubular member, the device comprising: an elongated tubular body comprising an outer layer, an inner layer and opposite open ends, wherein the inner layer has a first surface for connecting to the outer layer and a second surface for connecting to the tubular member.

In aspects, the device is orientatable between an open configuration wherein a first edge and a second edge of inner layer and/or the outer layer are drawn away from each other to form a longitudinal opening in the body and a closed configuration wherein the first edge and the second edge of the inner layer and/or the outer layers are drawn together.

In aspects, the device described herein further comprises a seam member.

In aspects, the seam member comprises a planar body and a projecting member extending along a length of the planar body.

In aspects, the seam member is insertable within the longitudinal opening and attachable to the first and second edges of the inner layer and/or outer layer of the body.

In aspects, the seam member spans a portion of the longitudinal opening or spans an entire length thereof.

In aspects, the seam member further comprises a backing member, wherein when the backing member is removed, the seam member can be attached to the first and second edges of the inner layer and/or outer layer.

In yet still further aspects, there is provided a gripping device for attachment to a tubular member, the device comprising: an elongated tubular body comprising an outer layer, an inner layer and opposite open ends, wherein the inner layer has a first surface for connecting to the outer layer and a second surface for connecting to the tubular member and wherein the device is orientatable between an open configuration wherein a first edge and a second edge of the inner layer and/or the outer layer are separated from each other to form a longitudinal opening in the body and a closed configuration wherein the first edge and the second edges of the inner layer and/or the outer layer are connected through a seam member.

In aspects, the seam member comprises a planar body and a projecting member extending along a length of the planar body

In aspects, the seam member further comprises a backing member, wherein when the backing member is removed, the seam member can be attached to the first and second edges of the inner layer and/or outer layer.

In aspects, the device described herein further comprises at least one recess and at least one ridge formed in a surface of the gripping device.

In aspects, the surface is a surface of the outer layer of the gripping device.

In aspects, there is at least one recess and at least one ridge that are positioned to conform to a placement of fingers of a hand.

In aspects, the device described herein further comprises fastening elements configured to secure the gripping device to the tubular member.

In aspects, the fastening elements are hook and loop fasteners.

In aspects, the hook and loop fastener is Velcro.

In aspects, the tubular member is selected from the group consisting of a seat tube, garden tool, a handle bar, a walking cane, and a ski pole.

In aspects, the tubular member is a seat tube.

In aspects, the inner layer adheres to a portion of the seat tube.

In aspects, the portion of the seat tube is a top tube.

In aspects, the portion of the seat tube is a down tube.

In aspects, wherein the outer layer comprises a resilient sheet of material.

In aspects, the outer layer is made of polyethylene or rubber.

In aspects, the inner layer comprises a foam pad, a backing sheet and an adhesive layer.

In aspects, the inner layer is made of polyethylene.

According to an aspect of the present invention, a cushioned gripping device is provided for selective attachment to the elongated seat tube of a bicycle. It includes a pad of foam-like resilient material dimensioned to substantially encircle the seat tube of the bicycle and is elongated to extend along a substantial length of the seat tube. The pad can be mounted to the seat tube of the bicycle by means of a layer of pressure sensitive adhesive material on the pad and generally coextensive therewith. In this instance, a releasable backing sheet may overlie the layer of adhesive material. The backing sheet can be removed enabling the gripping device to be attached to the seat tube of the bicycle. A resilient sheet of rubber-like material may overlie the pad to extend the life of the foam-like material. In another instance, the gripping device may be attached by means of hook and loop material having one component integral with the pad and another component capable of attachment to the seat tube of the bicycle. In another embodiment, the gripping device may have a contoured outer surface to improve the ability of a person to maintain a proper grip. Also, the gripping device may be tubular having an inner diameter substantially similar to the outer diameter of the seat tube of the bicycle and cut longitudinally to define opposed longitudinally extending edges which are drawn together into a facing proximate relationship when the pad is attached to the seat tube of the bicycle. Yet again, the gripping device may be generally planar and rectangular, having a width dimension generally equal to the outer periphery of the seat tube.

An aspect of an object of the invention is to provide a cushioned gripping device of customized size and placement for attachment to the elongated seat tube of a bicycle or other parts of the bicycle frame having a tubular configuration that might be gripped for the express purpose of manually lifting and transporting the bicycle.

Another aspect of an object of the invention is to provide a cushioned gripping device such that it utilizes existing materials and is inexpensive to manufacture.

A further aspect of an object of the invention is to provide a cushioned gripping device such that it is re-usable.

Still another aspect of an object of the invention is to provide the kind of cushioned gripping device, which can be readily applied to a receiving surface and which will accommodate a broad range of sizes and shapes of such receiving surfaces.

Yet another aspect of an object of the invention is to provide a cushioned gripping device such that it is tubular shaped and longitudinally slit on one side enabling it to be opened against its resilience for reception on the seat tube of the bicycle, then to snap to a closed position tightly engaging the outer surface of the seat tube.

Still a further aspect of an object of the invention is to provide a cushioned gripping device such that it is generally of flattened construction, able to be cut to conform to the size and shape of the seat tube to which it is to be attached.

The novel features of the present invention will become apparent to those of skill in the art upon examination of the following detailed description of the invention. It should be understood, however, that the detailed description of the invention and the specific examples presented, while indicating certain aspects of the present invention, are provided for illustration purposes only because various changes and modifications within the spirit and scope of the invention will become apparent to those of skill in the art from the detailed description of the invention and claims that follow.

### BRIEF DESCRIPTION OF THE DRAWINGS

The present invention will be further understood from the following description with reference to the Figures, in which like numbers denote like parts:

FIG. 1 is a perspective view of a gripping device in accordance with the present invention;

FIG. 2 is yet another perspective view of the gripping device of FIG. 1 shown in two attachable pieces in accordance with the present invention;

FIG. 3 is a perspective view of a sandwiched structure from which the gripping device of FIG. 1 can be fabricated;

FIG. 4 is a cross sectional view taken generally along line 4-4 in FIG. 3;

FIG. 5 is a cross sectional view of another embodiment of the sandwich structure in accordance with the present invention;

FIG. 6 is a top plan cross sectional view of the gripping device taken generally along line 6-6 in

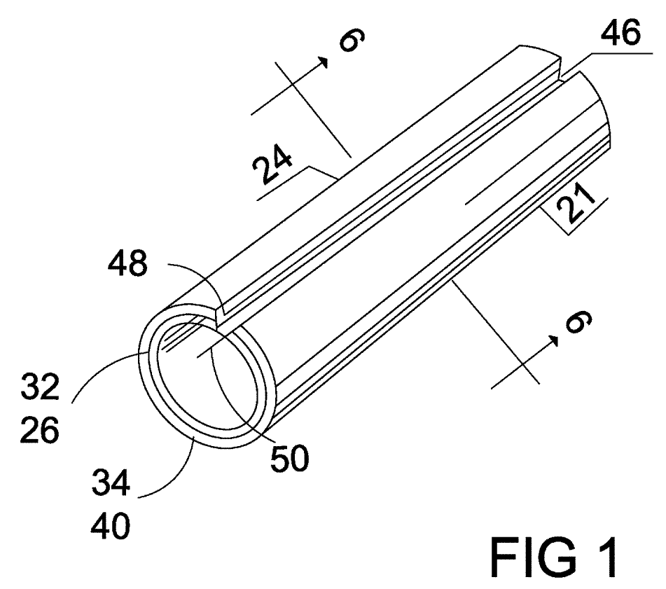

FIG. 1;

FIG. 7 is a diagrammatic end elevational view illustrating the manner of attaching the sandwiched structure to a seat tube of a bicycle frame in accordance with the present invention;

FIG. 8 is a perspective view of a gripping device (in solid lines) in accordance with the present invention shown attached to a seat tube (in stipple lines);

FIG. 9 is a diagrammatic end elevational view of the gripping device of FIG. 8 illustrating finger recesses on the exterior surface thereof in accordance with the present invention; and

FIG. 10 is a cross sectional view taken along line 10-10 in FIG. 9 illustrating another embodiment of the invention;

FIG. 11 shows a perspective view of a further embodiment of the gripping device of the present invention.

FIG. 12 shows another perspective view of the gripping device of FIG. 11.

FIG. 13 shows a side elevational view of the gripping device of FIG. 11.

FIG. 14 shows a bottom elevational view of the gripping device of FIG. 11 showing this gripping device in an open configuration revealing a seam member.

FIG. 15 shows a perspective view of the seam member of the gripping device of FIG. 14.

FIG. 16 shows a cross sectional view of the seam member taken along line 16-16 on FIG. 15.

FIG. 17 shows a close up view of the gripping device of FIG. 11 on a seat tube of a bicycle being gripped by a user.

### DETAILED DESCRIPTION

Referring to FIG. 1 as shown is the gripping device 24 of the present invention. The gripping device 24 comprises an elongated tubular body 21, having an outer layer 40 and an inner layer 26, with opposite vertical open edges 48 and 50 respectively. In aspects, the outer layer comprises a resilient layer of material 40 and the inner layer comprises a foam pad 26, a backing sheet 34 and an adhesive layer 32.

In aspects, the elongated tubular body 21 is formed or molded from plastic material, so as to provide in certain areas thereof, flexible sections, while also affording rigidity and strength to the overall tubular body 21.

In aspects, when the gripping device 24 is cut lengthwise on one side, it forms a longitudinal opening 46 having opposed edges 48 and 50. In aspects, the gripping device 24 can be attached to a seat tube 22 by drawing the edges 48 and 50 apart and the backing sheet 34 is removed to expose the adhesive layer 32 for pressure application to the surface of the seat tube 22. In this way, the opposed edges 48 and 50 can expand over the seat tube 22 and thereafter collapse or return back to unexpanded tubular body shape as shown in FIG. 1.

In aspects, the gripping device 24 may be produced in a tubular form, such as, an elongated cylindrical/tubular component 21. In aspects, the gripping device 24 can be cut longitudinally to make for the proper reception on the seat tube 22 of the bicycle.

In aspects, the griping device 24 can be placed on a seat/saddle tube 22 by first providing a gripping device 21 for placement on the seat tube 22.

In aspects, the outer layer 40 is formed of a plastic material in a radial or extended state.

In aspects, the outer layer 40 is configured to provide a secure and comfortable hold on the seat tube 22 for a user.

In aspects, the inner layer 26 can be applied in a fashion to allow the outer layer 40 to maintain a proper grip.

Advantageously, when the gripping device 24 is cylindrical in shape it accommodates a person's hand grasping the particular part of the bicycle frame which would normally be situated immediately above the area of the “front derailleur” on the seat tube 22 of the frame.

It is contemplated that the gripping device 24 is not limited in its use to any particular part of the bicycle frame alone. It can also be placed on the “top tube” in very close approximation to the seat post an area that might be shown to contain a seat post clamp. In this position it would be used as a shoulder pad for an individual who might want to manually carry his bicycle (in a form that would be akin to the portaging manoeuvre normally associated with canoeing). The bicycle would be perched high on his shoulder while he supports the rest of the bicycle with his free hands.

It is contemplated that the gripping device 24 can be placed on the “down tube” of the bicycle frame in order to manually lift and carry the bicycle. In an illustrative fashion it would be demonstrated how the top tube can be rested on the user's shoulders. This procedure would involve grasping the “down tube” with one hand whilst the other hand can be placed on the seat tube gripping device 24.

In aspects, the outer layer 40 is formed from a softer material for comfort, but not at the expense of durability. It is contemplated that this outer layer 40 is such that it resists abrasion and is highly flexible. In aspects, a lightweight closed cell polyethylene foam or the like can be used for the outer layer 40 and/or the inner layer 26. In aspects, this material has a nonslip surface which improves control and safety, provides tear/tensile durability and resiliency to abuse and is particularly weather resistant. In this way, when the inner layer 26 is made of polyethylene material, the gripping device 24 may have improved slip-resistance when placed about the seat tube 22. In aspects, the outer layer 40 will have a Shore ‘A’ Durometer coefficient reading in the range of about 35 to 75, typically less than 60, which is ideally suited to provide for the best human interactive factor.

In aspects, the inner layer 26, or substrate portion, is factory fitted (a process referred to as “injection moulding”), to the outer layer 40 providing for a fixed attachment. In aspects another technique including an adhesive layer 32 formed from a mastic material can be used. The aforementioned inner layer 26 can be made from a material of substantially greater rigidity, having a Shore ‘A’ Durometer coefficient reading of 87. In this way, the substrate portion can create the sensation of concentrating the pressure of a user's grasp against the bicycle's frame.

The process of injection molding is known in the art. In aspects, the injection molding process can be bi-injection molding, co-injection molding or overmolding.

In aspects, the inner layer 26 may be laminated to the outer layer 40 by any suitable technique known in the art, such as by vulcanizing, flame laminating or with an adhesive.

Advantageously, the gripping device 24 is moulded from a plastic material with a high coefficient of friction while at the same time allowing for a safe hand grip. The plastic material used in the moulding of the gripping device 24 provides a good feel to the touch, and good friction with the hands skin. In addition, it provides adequate support after a fashion that will allow the user to loosen the tension of his or her grip without actually having to diminish or otherwise compromise his or her grip when manually lifting the bicycle.

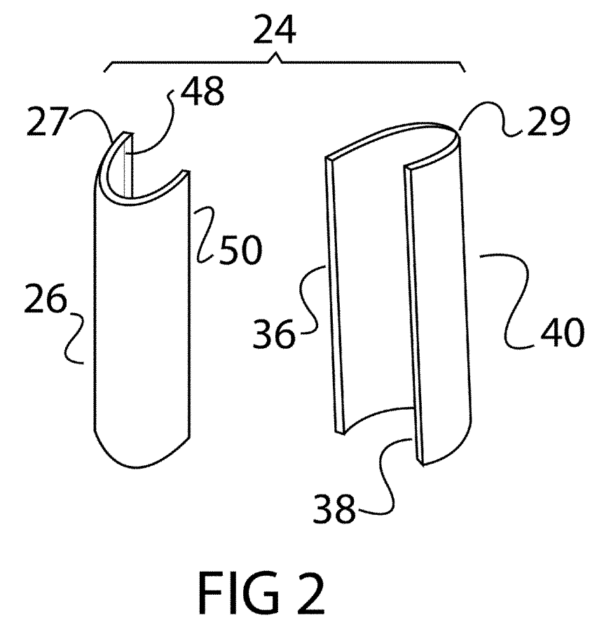

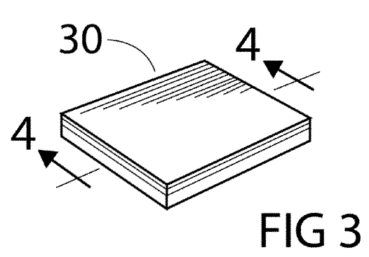

FIG. 2 is a perspective view of the sheets of material of the gripping device 24 shown as having at least two separate pieces 27 and 29 respectively. In this embodiment, these two separate and distinct sheet members comprising the inner layer 26 and the outer layer 40 respectively, which are longitudinally abutted against its self and these are arranged in an appositional manner. The inner layer 26 has the first long side 48, and the second long side 50. These two long sides being of equal length can abut each other around the circumference of the seat tube 22 of the bicycle. The outer layer 40 has a first long side 36 and a second long side 38, these two long sides also being of equal length allows for an almost seamless conjoint and these two sides abut each other in a similar fashion.

In aspects, the sheet members 27 and 29 are longitudinally abutted against one another around the periphery of the seat tube 22.

In aspects, the sheet members 27 and 29 are arranged in an appositional manner, with the location of the edges of the outer 40 and inner 26 sleeves being juxtaposed. Advantageously, this arrangement would not only guarantee the structural integrity of the gripping device 24, but ensures remarkable comfort to the user's hand.

In aspects, the outer 40 and inner 26 layers of the gripping device 24 are made of differing materials. In aspects, the outer 40 and inner 26 layers are made of the same material.

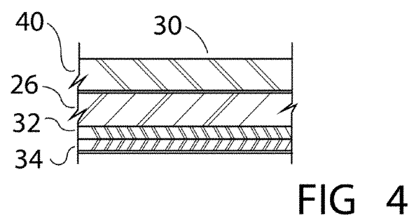

As shown in FIGS. 3-5, the gripping device 24 may be generally planar and rectangular, having a width dimension generally equal to the outer periphery of the seat tube 22. The gripping device 24 may, in its initial state, be a flat planar sandwiched structure 30. As shown in FIG. 4, the sandwiched structure 30 comprises the inner layer 26, the underlying layer 32 of adhesive, and a backing sheet 34.

In aspects, the adhesive 32 is a pressure sensitive adhesive. A suitable adhesive is a medical grade adhesive rubber. In preferred embodiments, the adhesive has at least a limited degree of stretchability to provide the ultimate control over the actual warpage and shaping of the device 24 around the seat tube 22.

In aspects, after the sandwiched structure 30 has been cut to the desired size, based on, but not limited to the dimensions of the bicycle, the backing sheet 34 can be removed by, for example, peeling. Once the backing sheet 34 is removed, the remainder of the sandwiched structure, now cut to size, can be properly aligned with a portion of the seat tube 22, such as, a center line of the seat tube 22, and then rolled (as indicated by arrows 35) onto the peripheral surface of the seat tube 22 causing it to adhere to the seat tube 22 by reason of the adhesive layer 32. When fully mounted, opposed edges 36, 38 (FIG. 2) are in juxtaposed position and are generally aligned with a longitudinal axis of the seat tube 22.

In aspects, the foam pad 26 of the sandwiched structure 30 may receive an overlying, contiguous, resilient pad 40 of rubber-like material. In aspects, the pad 40 would preferably be of a tougher but less resilient material than that of the foam pad 26. Advantageously, rubber-like pad 40 can improve the durability of the sandwiched structure 30. In aspects, the rubber-like pad 40 would be substantially more wear resistant than the foam pad 26. In addition, the resilient layer of rubber-like material 40 may overlie the pad to extend the life of the foam pad 26.

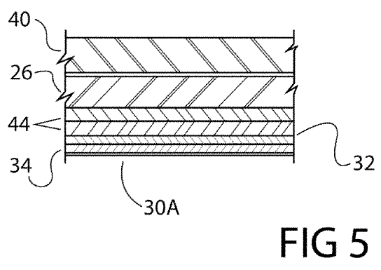

Turning to FIG. 5, a modified sandwiched structure 30A is shown. The structure 30A is similar to the sandwiched structure 30 of FIG. 4 with the exception of the addition of hook and loop fastening material 44, such as, VELCRO®. In aspects, one component of the hook and loop fastening material 44 can be semi-permanently attached to the seat tube 22 by means of the adhesive layer 32 while the other component remains integral with the foam pad 26. In aspects, the fastening material 44 can be permanently attached to the seat tube 22 by means of the adhesive layer 32, while the other component remains integral with the foam pad 26. In aspects, the fastening material is attachable to the foam pad 26 and removable therefrom.

In some embodiments the described device 24 is secured in place by the use of fastening elements that are secured to the flexible gripping surface and configured to engage cooperatively when the gripping device is wrapped around the seat tube 22 of the bicycle frame.

Advantageously, the semi-permanent construction allows for periodic removal of the foam pad 40 when it has been worn to an extent that it no longer serves its intended function. In this way, it may be replaced with a new foam pad. As in the instance of the sandwiched structure 30, the modified sandwiched structure 30A may also provide for a rubber-like sleeve 40 overlying the foam pad 26.

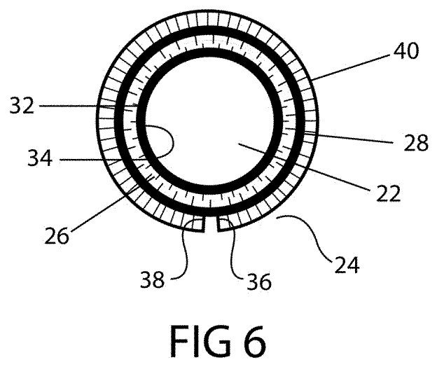

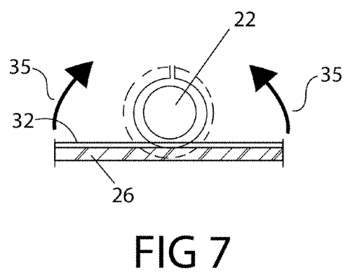

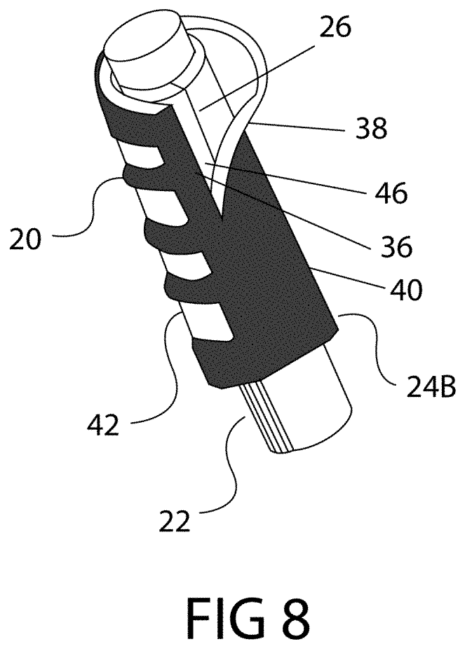

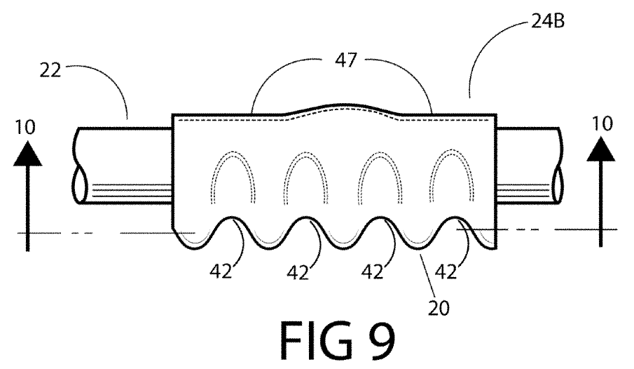

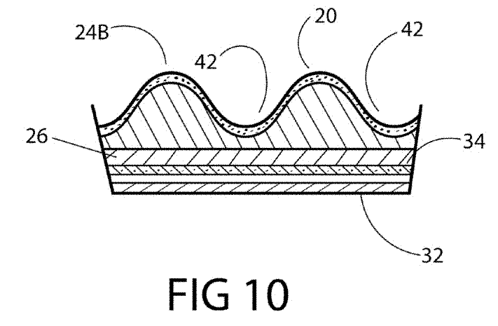

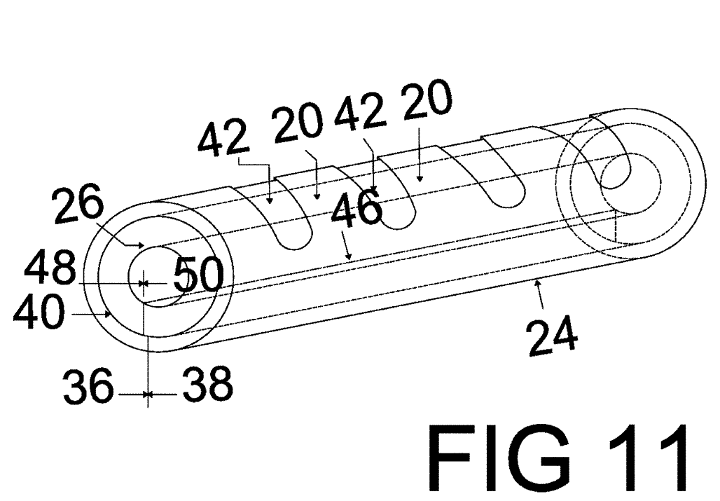

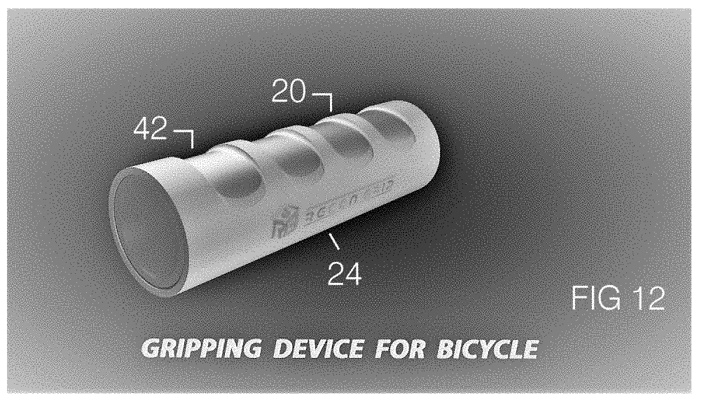

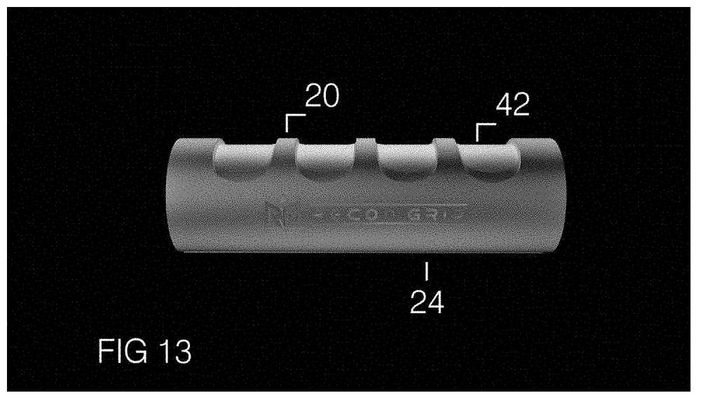

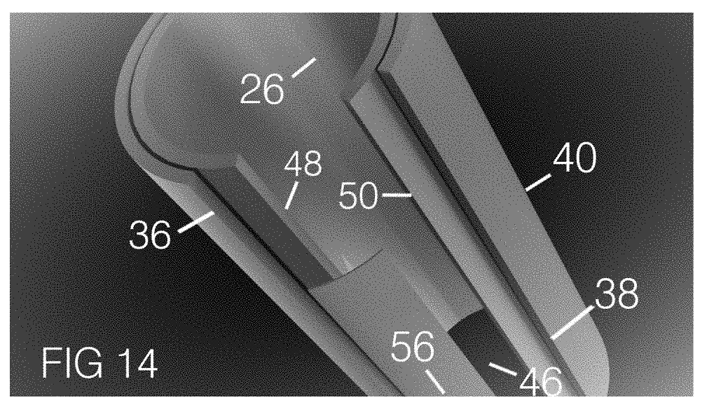

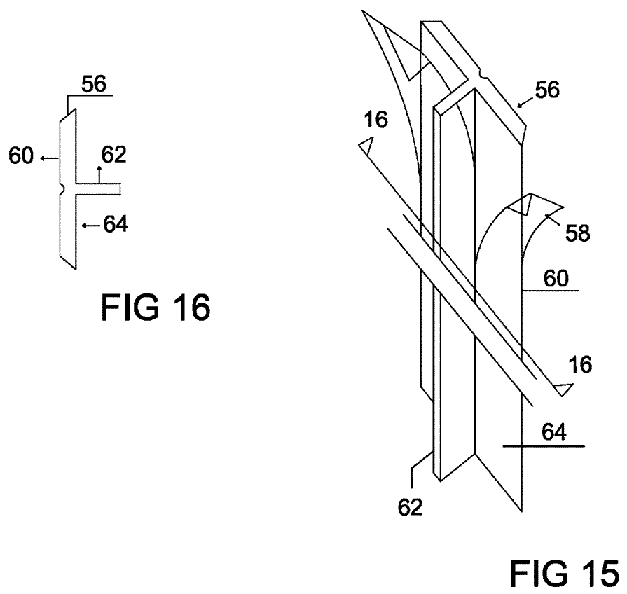

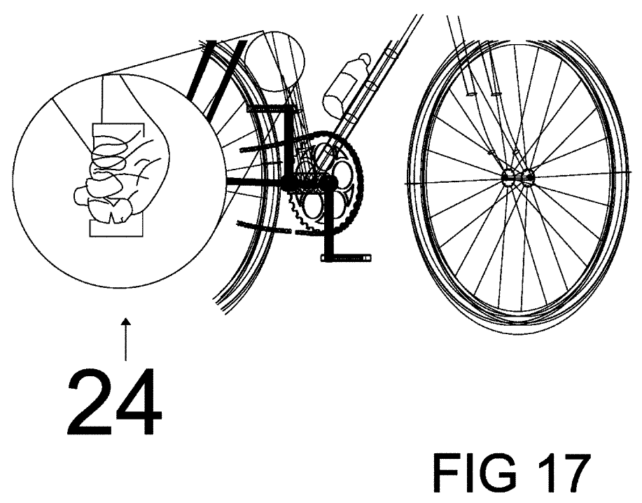

As seen in FIG. 6, the pad 26 of the gripping device 24 is dimensioned to substantially encircle the seat tube 22 and, typically, is elongated so as to extend along a substantial length of the seat tube 22. As described above, an appropriate attachment mechanism 28, such as the adhesive layer 32, or other suitable type of suture is employed for mounting the pad 26 to the pad 40.

Because the seat tubes 22 of a bicycles may be of a wide variety of sizes, shapes, and even cross sections (for example, round, oval, oblong and the like), it is contemplated that the sandwiched structure 30 has both a nominal size which, when so desired, can be cut to a final desired size at which point it should become necessary to apply it to a seat tube 22. For example, the final gripping device may have a diameter from about 40 mm to about 48 mm, depending upon the diameter of the seat tube 22. In specific embodiments the outer diameter of the outer layer 40 of the gripping device 24, 24B is 40.6 mm or 41.8 mm or 43.8 mm or 46.9 mm or 48.4 mm.

Typically, the pad 26 would be supplied with specific part numbers to represent the actual periphery and configuration for that particular model of the bicycle.

As diagrammatically depicted in FIG. 7 for example, it could be cut by means of scissors or suitable knife, widthwise, to a dimension to assure that it would substantially encircle the periphery of the seat tube 22. It will be appreciated that although the seat tube 22 is depicted in the drawings as being round, it may actually be any of a plethora of desired shapes and the invention is able to accommodate that, or any other particular shape that might be desired.

As shown in FIGS. 8 to 17, yet another embodiment of the present invention is shown that is attached to the seat tube 22. The gripping device 24B comprises the outer 40 and inner 26 layers are herein described, and at least one recess 42 and at least one ridge 20 formed in an exterior surface of the outer layer 40. In aspects, there is a plurality of recesses 42. For example, as shown, the recesses 42 are part of a partially modified foam pad 40 which has been altered specifically to have undulations at the point of the finger lobes. Advantageously, these recesses 42 contribute to superior comfort and reduced fatigue to every part of the hand since they are designed to coincide with the location of the user's fingers. In preferred embodiments, there are four recesses 42 and four ridges 20.

In aspects, these alternating recesses 42 and ridges 20 are meant to conform to the locations of fingers and spaces, respectively, not unlike that between the fingers of a user's hand. Thus, the fingers of a user's hand may comfortably rest within the recesses 42 while the ridges 20 generally conform to and are positioned in the spaces between the fingers of a user's hand

In aspects, when the gripping device 24B is mounted on the seat tube 22 as herein described, it may be necessary to rotate the tubular body 24B relative to the seat tube 22 to position the recesses 42 and ridges 20 for gripping by the user.

Advantageously, when the gripping device 24B is fitted on the seat tube 22, the device 24B assumes the same shape generally of the cylindrical body to which it is attached and the recesses 42 and ridges 20 allow for bonding with the location of, and the shape of the fingers of the user.

In aspects, the recesses 42 are positioned opposite the opening 46 of the tubular body 24B. In aspects, the recesses 42 and ridges 20 may be formed when the opposite edges 36 and 38 of the device 24B are brought together and collapse about the seat tube 22.

As shown in FIG. 9, the gripping device 24B further comprises certain high force points 47. In aspects, a tactile surface can be designed to give the gripping device 24B a superior feel, maximum comfort, while conforming to shape and contour of palm and fingers of user. At high force points 47, extra friction can be designed into the grip 24B. Ribs, grooves or surface texturing can also be used to improve the tactile feel.

In aspects, the gripping device 24B automatically aligns itself with a longitudinal axis of the seat tube 22.

FIG. 10 shows a cross sectional view with the gripping device 24B of FIG. 9 attached to the seat tube 22. The recesses 42 may be moderately roughened so as to have undulations or other physical features which will better enable a user to grip and maintain that grip on the seat tube 22. Of course, it will be appreciated that if the rubber-like pad 40 overlies the foam pad 26, then the undulations will actually be in the outer rubber-like pad 40 only and it will be completely separate from the foam pad 26. In aspects, the recesses 42 form a part of the rubber pad 40 and the foam pad 26.

As shown in FIG. 14, the gripping device 24B can assume an open configuration (e.g. can be opened against its own resilience) via the longitudinal opening 46 for reception on the seat tube 22 by drawing back the long edges 48 and 50 of the inner layer 26 and/or drawing back the edges 36 and 38 of the outer layer 40 and then return to a closed configurations so as to tightly engage the outer surface of the seat tube 22. As shown in FIG. 15 the device 24B may further comprise a seam member 56. The seam member 56 maybe attached to the device 24B or it may be a separate part, attachable thereto. For example, the seam member 56 may be integral with one of the edges 36 and 38 of the outer layer 40 as described below. With respect to the integral seam member 56 when the user is ready to secure the device 24B to the seat tube 22 the user would only need to secure the seam member to the other edge of the device 24B, this assists with ease of securing the device 24B to the seat tube 22. With respect to the seam member 56 being connectable to the device 24B (i.e. not integral therewith), once the device 24B has been set in place as described herein, the seam member 56 can be set in place. The seam member is set in place initially by placing the ridge 62 which projects above the surface of the planar body 60 into the narrow space between the edges 48 and 50, when the device 24B is set around the periphery of the seat tube 22. This allows the seam member 56 to be held rigidly in place. The flange 64 which projects on either side of the ridge 62 of the planar body 60, will thus overlap the otherwise exposed edges 48 and 50. In any regard, the seam member functions to provide a seal over the longitudinal opening 46 (e.g. A portion or the entire length thereof), so that the device 24 or 24B assumes the closed configuration over the seat tube 22 (FIG. 17).

The seam member 56 comprises a planar body 60 and a projecting ridge 62, extending along a surface of a planar body (see FIG. 15 or FIG. 16). The seam member 56 further comprises a backing sheet 58 (FIG. 15) that, when removed, allows for an underlying pressure sensitive adhesive layer to bond to edges 36 and 38 of the outer layer 40 such that when the seam member 56 is inserted therebetween, the seam member 56 becomes attached (e.g. Connected) to the edges 36 and 38. In this way, the seam member 56 seals at least a portion of the longitudinal opening 46. In aspects, the seam member 56 is the entire length of the longitudinal opening 46. In aspects the seam member 56 engages the edges 48 and 50 of the inner layer 26 in the same way described herein for edges 36 and 38. In aspects the seam member 56 engages both the inner layer 26 and the outer layer 40 through their edges as herein described. Advantageously the seam member 56 requires nothing more than the pressure force applied by one's finger tips to provide for proper bonding.

While FIG. 17 shows a readily recognisable placement of the gripping device as if to suggest a singular or preferred location on the bicycle frame, it is contemplated that the gripping device 24 or 24B of the present invention can be placed along the entire length of the seat tube 22. For example, the gripping device 24 or 24B can be positioned at, a top tube, head tube or down tube in a custom manner to suit the user. This arrangement is not limiting to the invention as herein described. Although the length of the gripping device 24 or 24B would be arbitrarily determined, it does not preclude any options that might be open to the user, any custom longitudinal length can be chosen by the user as well as it's placement on the seat tube 22. In addition, the user can also decide upon the number and spacing of the gripping devices 24 or 24B to be attached along the length of the seat tube 22. In this way, the user may benefit from protection for the palms and fingers of the hand. Although the description has been directed to the attachment of the gripping devices 24 and 24B of the invention, to the seat tube 22 of the bicycle frame and, specifically, a bicycle, such use is not intended nor should it be misconstrued as placing limitations on the scope or the influence of the invention. In actual fact, the invention may have many applications, included but not limited to, uses on any device which comprises a handle or handles, viz: garden tool implement handles, wheelbarrow metal handle bars, walking cane, crutch hand grip, ski pole hand grip, push handles for a wheel chair, handle grips for retractable luggage, hand grips for walker aided devices, snow throwers and exercise equipment handle bars plus a host of other types of apparatus.

It is contemplated that the gripping device 24B can be made by any known method in the art. For example, the gripping device 24B can be made using the method involving a process referred to as “injection moulding” which is the most frequently used technique for manufacturing parts made of thermoplastic materials [TPEs].

In aspects, a “soft feel” texture can be achieved by using a soft material that might have a hardness that is less than 60 Shore ‘A’ and a thickness of at least 1.5 mm. Typically the thickness would be from 1.5-2.0 mm. In this instance both the soft material and the hard substrate can be felt when grasping the gripping device 24 or 24B. By “soft feel” it is meant to imply a material that is malleable having little resistance to pressure, a perception normally learnt by touching or being aware through the senses, having a particular effect conveyed by the sense of touch. This can be a layer of foam that imparts a soft textured feel very similar to that obtained from cork like material, velvety foam or open cellular foam rubber (thermoplastic elastomeric), a material which is compliant and soft feeling, or anything that equates to a soft touch which gives the sample a tactile feel.

Aesthetics play a large role in the design of the gripping device 24 and 24B. Common issues regarding the appearance of any device are colour, surface finish, uniformity and texture. This can be achieved by creating a unit in which the soft grip will be a different colour to the rigid substrate portion.

Advantageously, the present invention provides for a cushioned gripping device 24 or 24B for selective attachment to the seat tube 22 of a bicycle. In particular, it serves to improve the ability of a person to maintain their grip on the bicycle frame while manually lifting the same, and at the same time cushioning the user's hand and providing protection against abrasion.

Advantageously, by use of the present invention (when applied to, for example, the bicycle seat tube 22), a cyclist, who might have been riding for an extended period of time, especially in hot and humid weather, now has a suitable gripping device 24 and 24B that allows for the cyclist to grip and manually lift the bicycle without fear of losing control because of sweat on the hands (sweaty palms). A condition which might result in the user losing his or her grip on the bicycle frame/seat tube 22. Accordingly, this will avert any possibility of injury caused by the bicycle inadvertently colliding with the cyclist. Given the frequency of life's unguarded moments and the attendant bodily discomforts so often brought on at these seemingly inopportune moments, the user can rest assured there would be no need to exert increased energy to control the bicycle while attempting to manually lift and transport it.

Advantageously, the gripping device 24 and 24B of the present invention is intended to provide the bicycle user the added comfort and a higher degree of ease not otherwise possible when manually lifting the bicycle. Hence no longer would the user need to apply or assert the force that until now would have required a much firmer grasp by one's hand to the bare metal frame of the bicycle.

The above disclosure generally describes the present invention. Although specific terms have been employed herein, such terms are intended in a descriptive sense and not for purposes of limitation.

Patent applications, patents, and publications are cited herein to assist in understanding the embodiments described. All such references cited herein are incorporated herein by reference in their entirety and for all purposes to the same extent as if each individual publication or patent or patent application was specifically and individually indicated to be incorporated by reference in its entirety for all purposes. To the extent publications and patents or patent applications incorporated by reference contradict the disclosure contained in the specification, the specification is intended to supersede and/or take precedence over any such contradictory material.

Although specific embodiments of the invention have been described herein in detail, it will be understood by those skilled in the art that variations may be made thereto without departing from the spirit of the invention or the scope of the appended claims.

It will be understood that certain of the above-described structures, functions, and operations of the above-described embodiments are not necessary to practice the present invention and are included in the description simply for completeness of an exemplary embodiment or embodiments. In addition, it will be understood that specific structures, functions, and operations set forth in the above-described referenced patents and publications can be practiced in conjunction with the present invention, but they are not essential to its practice. It is therefore to be understood that the invention may be practiced otherwise than as specifically described without actually departing from the spirit and scope of the present invention as defined by the appended claims Unless otherwise explained, all technical and scientific terms used herein have the same meaning as commonly understood by one of ordinary skill in the art to which this disclosure belongs. Although any methods and materials similar or equivalent to those described herein can be used in the practice for testing of the present invention, the typical materials and methods are described herein. In describing and claiming the present invention, the following terminology will be used.

When introducing elements disclosed herein, the articles “a”, “an”, “the”, and “said” are intended to mean that there may be one or more of the elements.

Any range described herein is understood to include any incremental ranges or individual values therebetween.

In understanding the scope of the present application, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. It will be understood that any embodiments described as “comprising” certain components may also “consist of” or “consist essentially of,” wherein “consisting of” has a closed-ended or restrictive meaning and “consisting essentially of” means including the components specified but excluding other components except for materials present as impurities, unavoidable materials present as a result of processes used to provide the components, and components added for a purpose other than achieving the technical effects described herein. For example, a composition defined using the phrase “consisting essentially of” encompasses any known pharmaceutically acceptable additive, excipient, diluent, carrier, and the like. Typically, a composition consisting essentially of a set of components will comprise less than 5% by weight, typically less than 3% by weight, more typically less than 1% by weight of non-specified components.

It will be understood that any component defined herein as being included may be explicitly excluded from the claimed invention by way of proviso or negative limitation, such as any specific compounds or method steps, whether implicitly or explicitly defined herein.

In addition, all ranges given herein include the end of the ranges and also any intermediate range points, whether explicitly stated or not.

Finally, terms of degree such as “substantially”, “about” and “approximately” as used herein mean a reasonable amount of deviation of the modified term such that the end result is not significantly changed. These terms of degree should be construed as including a deviation of at least ±5% of the modified term if this deviation would not negate the meaning of the word it modifies.

The abbreviation, “e.g.” is derived from the Latin exempli gratia, and is used herein to indicate a non-limiting example. Thus, the abbreviation “e.g.” is synonymous with the term “for example.” The word “or” is intended to include “and” unless the context clearly indicates otherwise.

The phrase “at least one of” is understood to be one or more. The phrase “at least one of . . . and . . . ” is understood to mean at least one of the elements listed or a combination thereof, if not explicitly listed. For example, “at least one of A, B, and C” is understood to mean A alone or B alone or C alone or a combination of A and B or a combination of A and C or a combination of B and C or a combination of A, B, and C. “At least one of at least one of A, at least one of B, and at least one of C” is understood to mean at least one of A alone or at least one of B alone or at least one of C alone or a combination of at least one of A and at least one of B or a combination of at least one of A and at least one of C or a combination of at least one of B and at least one of C or a combination of at least one of A, at least one of B, and at least one of C.

We claim:

1. A gripping device for attachment to a tubular member, the device comprising:
an elongated tubular body comprising an outer layer, an inner layer and opposite open ends, wherein the inner layer has a first surface for connecting to the outer layer and a second surface for connecting to the tubular member and wherein the device is orientatable between an open configuration wherein a first edge and a second edge of the inner layer and/or the outer layer are drawn away from each other forming a longitudinal opening and a closed configuration wherein the first edge and the second edge of the inner and/or the outer layers are drawn together.

2. The device of claim 2, further comprising a seam member.

3. The device of claim 2, wherein the seam member comprises a planar body and a projecting member connected to, extending along, a length of the planar body.

4. The device of claim 2, wherein the seam member is insertable within the longitudinal opening and attachable to the first and second edges of the inner and/or outer layer of the body.

5. The device of claim 2, wherein the seam member spans a portion of the longitudinal opening or spans an entire length thereof.

6. The device of claim 2, wherein the seam member further comprises a backing member, wherein when the backing member is removed, the seam member can be attached to the first edge and second edge of the inner layer and/or outer layers.

7. The gripping device of claim 1, further comprising at least one recess and at least one ridge formed in a surface of the gripping device.

8. The gripping device of claim 7, wherein the surface is a surface of the outer layer and/or the inner layer of the gripping device.

9. The gripping device of claim 7, wherein at least one recess and at least one ridge are positioned to conform to a placement of fingers of a hand.

10. The gripping device of claim 1, further comprising fastening elements configured to secure the gripping device to the tubular member.

11. The gripping device of claim 10, wherein the fastening elements are hook and loop fasteners.

12. The gripping device of claim 1, wherein the tubular member is selected from the group consisting of a seat tube, a garden tool, a handle bar, a walking cane, and a ski pole.

13. A gripping device for attachment to a tubular member, the device comprising:
an elongated tubular body comprising an outer layer, an inner layer and opposite open ends, wherein the inner layer has a first surface for connecting to the outer layer and a second surface for connecting to the tubular member and wherein the device is orientatable between an open configuration wherein a first edge and a second edge of inner and/or the outer layer are separated from each other to form a longitudinal opening and a closed configuration wherein the first edge and the second edge of the inner layer and/or the outer layer are connected through a seam member.

14. The gripping device of claim 13, wherein the seam member comprises a planar body and a projecting member extending along a length of the planar body.

15. The gripping device of claim 13, wherein the seam member further comprises a backing member, wherein when the backing member is removed, the seam member can be attached to the first and the second edge of the inner layer and/or outer layer.

16. The gripping device of claim 1, further comprising at least one recess and at least one ridge formed in a surface of the gripping device.

17. The gripping device of claim 16, wherein the surface is a surface of the outer layer and/or the inner layer of the gripping device.

18. The gripping device of claim 16, wherein at least one recess and at least one ridge are positioned to conform to a placement of fingers of a hand.

19. The gripping device of claim 1, further comprising fastening elements configured to secure the gripping device to the tubular member.

20. The gripping device of claim 1, wherein the tubular member is selected from the group consisting of a seat tube, a garden tool, a handle bar, a walking cane, and a ski pole.
